(19) United States
(12) Patent Application Publication
(10) Pub. No.: US 2024/0397123 A1
(43) Pub. Date: Nov. 28, 2024

(54) METHODS AND SYSTEMS FOR PROVIDING CONTENT

(71) Applicant: Comcast Cable Communications, LLC, Philadelphia, PA (US)

(72) Inventors: Rima Shah, Denver, CO (US); Maria Battle-Miller, Denver, CO (US)

(21) Appl. No.: 18/321,507

(22) Filed: May 22, 2023

(51) Int. Cl. H04N 21/234; H04N 21/422; H04N 21/81; H04N 21/8352

(52) U.S. Cl. CPC H04N 21/23424; H04N 21/42203; H04N 21/812; H04N 21/8352

(57) ABSTRACT

Content may be sent to a premises. One or more devices at the premises may be activated to detect audio associated with the content. The one or more devices at the premises may be activated based on timing data associated with the content. The detected audio may be used to determine that the content was output. One or more actions may be taken based on the determination that the content was output.

### BACKGROUND

Many of today's entertainment or communication-related electronic devices rely on receiving, sending, and/or using data (e.g., content). The data may include primary content (e.g., a movie) and/or secondary content (e.g., an advertisement). Content providers develop schedules for secondary content delivery (e.g., advertisement schedules) based on demographic and other information related to viewers. In determining an advertisement schedule, content providers attempt to strike a balance with respect to how often a viewer should be exposed to an advertisement. For example, users often feel annoyance or even anger when they see an advertisement too frequently. On the other hand, an advertisement's effectiveness (in terms of generating sales) is tied to how frequently a viewer is exposed to the advertisement. Thus, there is a need for determining exposure (e.g., tracking output) to secondary content such as advertisements, Current methods of determining exposure rely heavily on small blocks of data such as “cookies.” However, cookies present a particular problem. For example, some browsers and applications implement cookie blocking which may result in inaccurate tracking data. Cookie expiration may result in loss of tracking data. Cookies only track activity on a single device and thus cross-device tracking may not be accurate. Further, the use of cookies for tracking purposes has raised privacy concerns among users, and some may actively take steps to block or delete them. Additionally, the accuracy of the data collected through cookies can be impacted by various factors, such as browser settings, device settings, and network connectivity.

### SUMMARY

It is to be understood that both the following general description and the following detailed description are exemplary and explanatory only and are not restrictive. Content available over a content distribution network (CDN) is produced by content providers, which may include, without limitation, television networks, movie studios, video-sharing platforms, and countless other types of content providers. Generally, the content provider produces the content (which may include encoding the content) and makes the content available for distribution over the CDN. Content may be divided into discrete segments and a manifest file may be generated that sequentially lists the segments of a given piece of content along with their respective network locations. A user device can interpret the manifest file to fetch the video segments and assemble the video segments to play the video content. The manifest file may be checked to determine locations and timing of content, such as primary content and/or secondary content (e.g., advertisement breaks). The disclosure provides for an implementation where an ambient listening device may use the timing information to turn on, in a synchronized manner, to determine whether particular audio and associated video are being presented. For example, when a secondary content location/time is detected in the manifest file, an ambient microphone may be activated to detect audio associated with video segments being output by the user device. The detected audio may be analyzed to identify the content being output. The identification of the content via the detected audio may be used for content verification, content tracking, and the like. Turning on an ambient listening device only at particular intervals serves, among other things, to increase privacy for users, and decrease system resources.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a block diagram illustrating various aspects of an example system;

FIG. 1B is a block diagram illustrating various aspects of an example system;

FIG. 2 is an example table;

FIG. 3 is a flowchart illustrating an example method;

FIG. 4 is a flowchart illustrating another example method;

FIG. 5 is a flowchart illustrating another example method; and

FIG. 6 is a block diagram illustrating an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a.” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

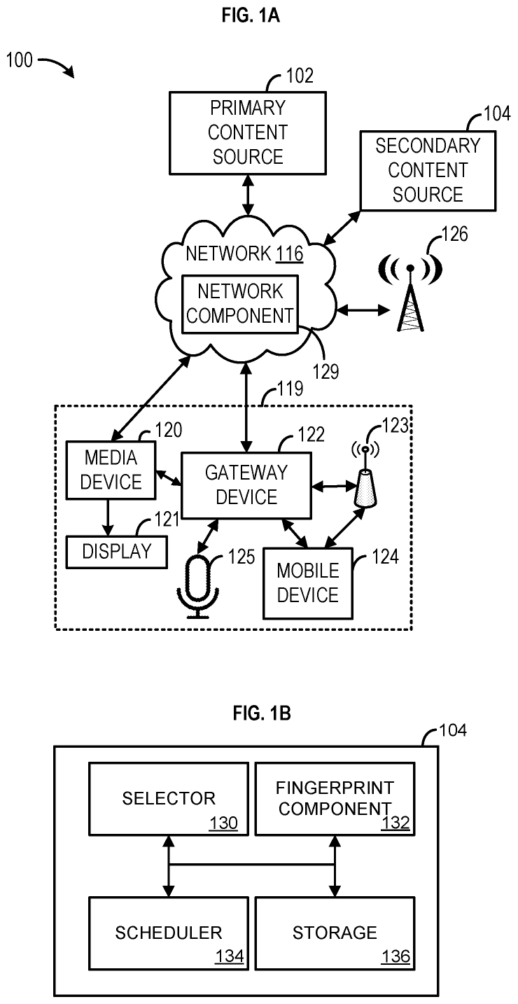

The present disclosure relates to methods and systems for delivering and managing content. FIG. 1 shows a system 100 for content distribution. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a primary content source 102, a secondary content source 104, a media device 120, a gateway device 122, and/or a mobile device 124. Each of the primary content source 102, the secondary content source 104, the media device 120, the gateway device 122, and/or the mobile device 124, can be one or more computing devices, and some or all of the functions performed by these components may at times be performed by a single computing device. The primary content source 102, the secondary content source 104, the media device 120, the gateway device 122, and/or the mobile device 124 may be configured to communicate through a network 116. The network 116 may facilitate sending content to and from any of the one or more device described herein. For example, the network 116 may be configured to facilitate the primary content source 102 and/or the secondary content source 104 sending primary content and/or secondary content to one or more of the media device 120, the gateway device 122, and/or the mobile device 124. The network 116 may be a content delivery network, a content access network, combinations thereof, and the like. The network 116 may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like. The network component 129 may be any device, module, combinations thereof, and the like communicatively coupled to the network 116. The network component 129 may also be a router, a switch, a splitter, a packager, a gateway, an encoder, a storage device, a multiplexer, a network access location (e.g., tap), physical link, combinations thereof, and the like.

The primary content source 102 may be configured to send content (e.g., video, audio, movies, television, games, applications, data, etc.) to one or more devices such as the media device 120, a network component 129, a first access point 123, a mobile device 124, an audio device 125, a distribution device 126, and/or the media device 120. The primary content source 102 may be configured to send streaming media, such as broadcast content, video on-demand content (e.g., VOD), content recordings, combinations thereof, and the like. For example, the primary content source 102 may be configured to send primary content, via the network 116, to the media device 120.

The primary content source 102 may be managed by third party content providers, service providers, online content providers, over-the-top content providers, combinations thereof, and the like. The content may be sent based on a subscription, individual item purchase or rental, combinations thereof, and the like. The primary content source 102 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., developed by a content provider, developed for a specific device), a general content browser (e.g., web browser), an electronic program guide, combinations thereof, and the like. The content may comprise signaling data.

The secondary content source 104 may be configured to send content (e.g., video, audio, movies, television, games, applications, data, etc.) to one or more devices such as the media device 120, the gateway device 122, the network component 129, the first access point 123, the mobile device 124, the audio device 125, and/or the distribution device 126. The secondary content source 104 may comprise, for example, a content server such as an advertisement server. The secondary content source 104 may be configured to send secondary content. Secondary content can comprise, for example, advertisements (interactive and/or non-interactive) and/or supplemental content such as behind-the-scenes footage or other related content, supplemental features (applications and/or interfaces) such as transactional applications for shopping and/or gaming applications, metadata, combinations thereof, and the like. The metadata may comprise, for example, demographic data, pricing data, timing data, configuration data, combinations thereof, and the like. For example, the configuration data may include formatting data and other data related to delivering and/or outputting the secondary content.

The secondary content source 104 may be configured to send streaming media, such as broadcast content, video on-demand content (e.g., VOD), content recordings, combinations thereof, and the like. The secondary content source 104 may be managed by third party content providers, service providers, online content providers, over-the-top content providers, combinations thereof, and the like. The content may be sent based on a subscription, individual item purchase or rental, combinations thereof, and the like. The secondary content source 104 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The secondary content source may be configured to send the secondary content based on, for example, one or more requests received from devices at a premises 119 including, for the example, the media device 120, the gateway device 122, the mobile device 124, or the audio device 125). For example, the media device 120 may request secondary content based on a manifest file, a program map table (e.g., PMT table), in-line signaling such as SCTE-35 signaling, combinations thereof, and the like. For example, the secondary content source may send secondary content comprising audio data to, for example, the media device 120. The secondary content may, en route between the secondary content source 104 and the media device, be routed through the distribution device 126. The distribution device 126 may comprise, for example, a cable headend. The distribution device may be configured to generate, determine, send, or otherwise process SCTE-35 signals or other markers. For example, the cable headend may generate and sends SCTE-35 signals configured to trigger the insertion of advertisements into a video stream. The SCTE-35 signals may be generated by the secondary content source 104.

The secondary content source 104 may use information about the secondary content being sent, such as the type of program, the time of day, and the target audience, to determine when and where to insert ads into the video stream. When the secondary content source 104 determines a content insertion opportunity, it may generate a SCTE-35 signal and send the SCTE-35 signal to the distribution device 126. The distribution device 126 may use the information in the SCTE-35 signal to insert the ad into the video stream. The SCTE-35 signal typically may contain information such as the start and end times of the ad, the type of ad (e.g., pre-roll, mid-roll, or post-roll), and the location of the ad within the video stream. This information may be used by the cable headend to determine when and where to insert the ad, and to ensure that the ad is displayed correctly within the video stream. While a primary content source and a secondary content source are described, it is to be understood that the methods and systems described herein may be carried out via a single “content source” type device.

As seen in FIG. 1B, the secondary content source 104 may comprise a content selector 130, a fingerprint component 132, a scheduler 124, and storage 136. The advertisement selector 130 may be configured to store one or more ad campaigns, one or more ad rotations, one or more ad schedules, combinations thereof, and the like. For example, the advertisement selector 130 may be configured to output secondary content based on the one or more ad campaigns, one or more ad rotations, one or more ad schedules, or the like. The scheduler 134 may be configured to store one or more ad schedules. The scheduler 134 may be configured to determine a number of times an advertisement may be output to a user and/or a device. The content storage component 136 may be configured to store secondary content.

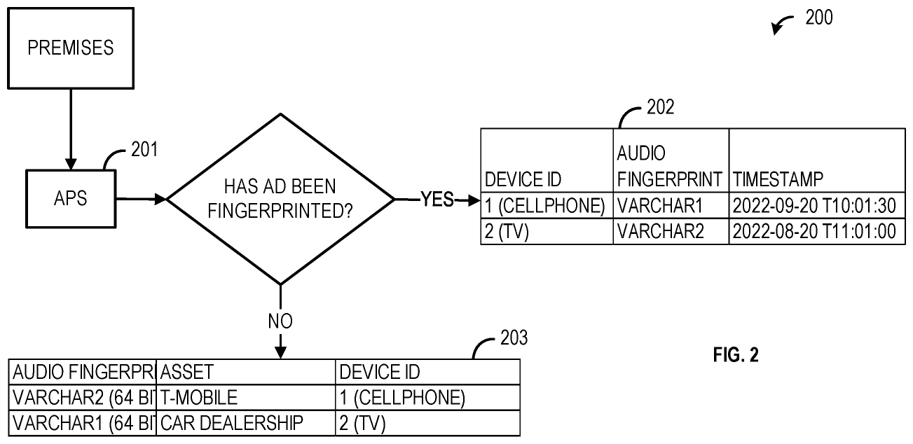

The fingerprint component 132 may be configured to generate, determine, send, receive, store, or otherwise process one or more audio fingerprints. As discussed below with respect to FIG. 2, the secondary content source 104 may, for example, send audio data comprising one or more audio fingerprints for output (e.g., by media device 120). The secondary content source 104 may receive audio data detected by one or more audio devices. The secondary content source 104 may determine the audio data detected by the one or more audio devices comprises the one or more fingerprints. By determining the audio data detected by the one or more audio devices comprises the one or more audio fingerprints, the secondary content source 104 may determine whether an ad campaign, ad schedule, or other rule or policy has been followed. For example, an advertiser may require that a piece of secondary content be output in a premises a certain number of times over a certain period of time and perhaps to a certain user. Thus, by activating the one or more audio devices and detecting output audio data that comprises the one or more audio fingerprints, the secondary content source 104 can determine whether one or more policies/campaigns have been executed.

The media device 120 may be configured to receive the primary content. The media device 120 may comprise a device configured to enable an output device (e.g., a display, a television, a computer or other similar device) to output media (e.g., content). For example, the media device 120 may be configured to receive, decode, transcode, encode, send, and or otherwise process data and send data to, for example, the display device 121. For example, the media device 120 may be configured to receive one or more manifest files. The media device 120 may be configured to send one or more requests for content based on the one or more manifest files. The one or more manifest files may, for example, comprise timing data, one or more file names, one or more paths, one or more file locations, one or more file sizes, one or more file dependencies, package metadata, one or more installation instructions, combinations thereof, and the like. The media device 120, may for example be configured to send one or more requests for content based on the one or more manifest files.

The media device 120 may be configured to receive a program map table (PMT). The PMT may comprise a data structure configured to describe the elementary streams that make up content (e.g., a broadcast program). The PMT may contain information about the type of data (audio, video, subtitle, etc.), codec used for encoding, and other relevant information needed for the decoder to properly process the stream. The PMT may be part of the MPEG-2 transport stream and may be used by a digital TV receiver (e.g., the media device 120) to identify and decode various elements of, for example, a TV program.

The PMT may be organized as a table, with each row of the table describing a single program in the transport stream. The PMT may include one or more program numbers (e.g., program IDs or “PIDs”). The one or more PIDs may be one or more unique identifiers identifying the program being described by the PMT. The PMT may comprise one or more Program Clock References (PCRs). The one or more PCRs may comprise timing data configured to synchronize audio, video, or other streams or data. The PMT may contain descriptive information such as a program name, genre, characters, subject matter, or other metadata. The PMT may comprise elementary stream information configured to describe the individual audio, video, and data streams in the program, including the type of data, the PID, and the codec used.

The media device 120 may be configured to activate one or more audio devices based on the information in the PMT. For example, the PMT may indicate a start time associated with a content insertion opportunity. The media device 120 may activate the one or more audio devices before the start time associated with the content insertion opportunity. The PMT may indicate a duration of the content insertion opportunity. The media device 120 may cause the one or more audio devices to enter a listen mode during the duration of the content insertion opportunity. The PMT may indicate an end time associated with the content insertion opportunity. The media device 120 may cause the one or more audio devices to deactivate and/or exit the listen mode based on the end time associated with the content insertion opportunity.

The media device 120 may be configured to process signaling data. For example, the media device 120 may be configured to process one or more SCTE-35 signals. The signaling data may be inserted by the primary content source 102 or secondary content source 104 in a Moving Picture Experts Group (MPEG) bitstream, MPEG Supplemental Enhancement Information (SEI) messages, MPEG-2 Transport Stream (TS) packet, MPEG-2 Packetized Elementary Stream (PES) header data, ISO Base Media File Format (BMFF) data, ISO BMFF box, or in any data packet. The signaling data may comprise one or more markers. For example, the signaling data may comprise Society of Cable and Television Engineers 35 (SCTE-35) markers. The Society of Cable Telecommunications Engineers 35 (SCTE35) is hereby incorporated by reference in its entirety. The Society of Cable Telecommunications Engineers 30 (SCTE30) and the Society of Cable Telecommunications Engineers 130 (SCTE130) are also hereby incorporated by reference in their entirety.

The one or more markers may be associated with one or more content insertion opportunities. For example, the one or more markers may precede and/or trail the one or more insertion opportunities in content. For example, the one or more markers may indicate that an advertisement break of the one or more advertisements breaks is inbound (e.g., upcoming in the content). For example, the one or more markers may be utilized to mark timestamps of events such as the one or more advertisement insertion points. For example, the one or more markers may indicate to a device which receives the one or more markers (e.g., media device 120), that an advertisement break in the content is upcoming (e.g., “inbound”) within a period of time (e.g., 2 seconds, 10 seconds, etc . . . ).

The one or more SCTE-35 signals may comprise, for example, a pre-roll signal. A SCTE-35 pre-roll signal may be configured to indicate that an advertisement or other content is about to be sent to/delivered to/received by the media device 120. The SCTE-35 signal may be sent, for example, by a cable headend to a cable modem or set-top box in a subscriber's home. The SCTE-35 pre-roll signal may comprise information such as the start time and duration of the content, as well as a content ID. The SCTE-35 pre-roll signal may be configured to trigger the insertion of content into the broadcast stream (e.g., at a certain time).

The one or more SCTE-35 signals may comprise, for example, an ad splice-in signal configured to indicates the start of an advertisement or other content in a broadcast stream, an ad splice-out signal configured to indicate the end of an advertisement or other content in the broadcast stream, a provider advertisement unit (PAU) signal, configured to provide information about the content of an advertisement, including the content ID, duration, target audience, or the like, a provider placements opportunity (PPO) signal configured to provide information about opportunities for advertisers to place content in the broadcast stream, including the start time, duration, target audience, and the like, a provider trigger signal configured to provide information about events or conditions that should trigger the insertion of specific content into the broadcast stream, or a provider playlist signal configured to provide information about the order and timing of advertisements or other content in the broadcast system.

The media device 120 may be configured to cause one or more audio devices to activate and record audio. For example, the media device 120 may activate the one or audio device based on receipt of the signaling data (e.g., the one or more SCTE-35 signals such as the pre-roll signal). For example, the media device 120 may activate a microphone associated with the media device 120 (e.g., either on the media device 120 or the display 121, a voice enable remote, or an auxiliary device). The media device 120 may send one or more instructions. The one or more instructions may be configured to activate the one or more audio devices, cause the one or more audio devices to record audio, and send the audio back to the media device 120. The media device 120 may send the received audio device to, for example, the gateway 122.

The media device 120 may be configured to receive the primary content. The media device 120 may comprise a device configured to enable an output device (e.g., a display, a television, a computer or other similar device) to output media (e.g., content). For example, the media device 120 may be configured to receive, decode, transcode, encode, send, and or otherwise process data and send data to, for example, the display device 121. For example, the media device 120 may be configured to receive one or more manifest files. The media device 120 may be configured to send one or more requests for content based on the one or more manifest files. The one or more manifest files may, for example, comprise timing data, one or more file names, one or more paths, one or more file locations, one or more file sizes, one or more file dependencies, package metadata, one or more installation instructions, combinations thereof, and the like. The media device 120, may for example be configured to send one or more requests for content based on the one or more manifest files.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via the gateway device 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the gateway device 122, a computer, a TV, a monitor, or a satellite dish. The gateway device 122 may be located at the premises 119. The gateway device 122 may send the content to the media device 120.

The gateway device 122 may be configured to receive the primary content. For example, the gateway device 122 may be configured to receive, decode, transcode, encode, send, and or otherwise process data and send data to, for example, the media device 120. For example, the gateway device 122 may be configured to receive one or more manifest files. The one or more manifest files may, for example, comprise timing data, one or more file names, one or more paths, one or more file locations, one or more file sizes, one or more file dependencies, package metadata, one or more installation instructions, combinations thereof, and the like.

The gateway device 122 may be configured to receive a program map table (PMT). The PMT may comprise a data structure configured to describe the elementary streams that make up content (e.g., a broadcast program). The PMT may contain information about the type of data (audio, video, subtitle, etc.), codec used for encoding, and other relevant information needed for the decoder to properly process the stream. The PMT may be part of the MPEG-2 transport stream and may be used by a digital TV receiver (e.g., the gateway device 122) to identify and decode various elements of, for example, a TV program.

The PMT may be organized as a table, with each row of the table describing a single program in the transport stream. The PMT may include one or more program numbers (e.g., program IDs or “PIDs”). The one or more PIDs may be one or more unique identifiers identifying the program being described by the PMT. The PMT may comprise one or more Program Clock References (PCRs). The one or more PCRs may comprise timing data configured to synchronize audio, video, or other streams or data. The PMT may contain descriptive information such as a program name, genre, characters, subject matter, or other metadata. The PMT may comprise elementary stream information configured to describe the individual audio, video, and data streams in the program, including the type of data, the PID, and the codec used.

The gateway device 122 may be configured to activate one or more audio devices based on the information in the PMT. For example, the PMT may indicate a start time associated with a content insertion opportunity. The gateway device 122 may activate the one or more audio devices before the start time associated with the content insertion opportunity. The PMT may indicate a duration of the content insertion opportunity. The gateway device 122 may cause the one or more audio devices to enter a listen mode during the duration of the content insertion opportunity. The PMT may indicate an end time associated with the content insertion opportunity. The gateway device 122 may cause the one or more audio devices to deactivate and/or exit the listen mode based on the end time associated with the content insertion opportunity.

The gateway device 122 may be configured to process signaling data. For example, the gateway device 122 may be configured to process one or more SCTE-35 signals. The signaling data may be inserted by the primary content source 102 or secondary content source 104 in a Moving Picture Experts Group (MPEG) bitstream, MPEG Supplemental Enhancement Information (SEI) messages, MPEG-2 Transport Stream (TS) packet, MPEG-2 Packetized Elementary Stream (PES) header data, ISO Base Media File Format (BMFF) data, ISO BMFF box, or in any data packet. The signaling data may comprise one or more markers. For example, the signaling data may comprise Society of Cable and Television Engineers 35 (SCTE-35) markers. The Society of Cable Telecommunications Engineers 35 (SCTE35) is hereby incorporated by reference in its entirety. The Society of Cable Telecommunications Engineers 30 (SCTE30) and the Society of Cable Telecommunications Engineers 130 (SCTE130) are also hereby incorporated by reference in their entirety.

The one or more markers may be associated with one or more content insertion opportunities. For example, the one or more markers may precede and/or trail the one or more insertion opportunities in content. For example, the one or more markers may indicate that an advertisement break of the one or more advertisements breaks is inbound (e.g., upcoming in the content). For example, the one or more markers may be utilized to mark timestamps of events such as the one or more advertisement insertion points. For example, the one or more markers may indicate to a device which receives the one or more markers (e.g., gateway device 122), that an advertisement break in the content is upcoming (e.g., “inbound”) within a period of time (e.g., 2 seconds, 10 seconds, etc . . . ).

The gateway device 122 may be configured to cause one or more audio devices to activate and record audio. For example, the gateway device 122 may activate the one or audio device based on receipt of the signaling data (e.g., the one or more SCTE-35 signals such as the pre-roll signal). For example, the gateway device 122 may activate a microphone associated with the gateway device 122 (e.g., either on the gateway device 122 or the display 121, a voice enable remote, or an auxiliary device). The gateway device 122 may send one or more instructions. The one or more instructions may be configured to activate the one or more audio devices, cause the one or more audio devices to record audio, and send the audio back to the gateway device 122.

The one or more SCTE-35 signals may comprise, for example, a pre-roll signal. A SCTE-35 pre-roll signal may be configured to indicate that an advertisement or other content is about to be sent to/delivered to/received by the gateway device 122. The SCTE-35 signal may be sent, for example, by a cable headend to a cable modem or set-top box in a subscriber's home. The SCTE-35 pre-roll signal may comprise information such as the start time and duration of the content, as well as a content ID. The SCTE-35 pre-roll signal may be configured to trigger the insertion of content into the broadcast stream (e.g., at a certain time).

A first access point 123 (e.g., a wireless access point) may be located at the premises 119. The first access point 123 may be configured to provide one or more wireless networks in at least a portion of the premises 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the gateway device 122, the media device 120, and the display device 121 may be implemented as a single device.

The premises 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123.

FIG. 2 illustrates various aspects of an example method 200 in which the present methods and systems can operate. The system 200 may comprise an advertisement processing system (APS) 201. The APS may be configured to receive one or more manifest files. Based on the manifest file, the APS 201 may identify one or more content insertion opportunities and timing data associated with the one or more content insertion opportunities. The one or more content insertion opportunities may comprise one or more opportunities to insert, or otherwise send or cause output of, secondary content between primary content. For example, the one or more content insertion opportunities may comprise one or more advertisement breaks, one or more in-frame advertisements (e.g., banner ads, picture in picture, etc.). The timing data may indicate one or more start times associated with the one or more content insertion opportunities, one or more end times associated with the one or more content insertion opportunities, one or more durations associated with the one or more content insertion opportunities, combinations thereof, and the like.

The APS 201 may be configured to send, receive, store, or otherwise process secondary content. The secondary content may comprise, for example, advertisements (interactive and/or non-interactive) and/or supplemental content such as behind-the-scenes footage or other related content, supplemental features (applications and/or interfaces) such as transactional applications for shopping and/or gaming applications, metadata, combinations thereof, and the like. The metadata may comprise, for example, demographic data, pricing data, timing data, configuration data, combinations thereof, and the like. For example, the configuration data may include formatting data and other data related to delivering and/or outputting the secondary content. The secondary content may comprise audio data (e.g., an audio track).

The APS 201 may be configured to send secondary content. For example, the APS 201 may be configured to send secondary content based on one or more requests for secondary content. For example, the APS 201 may be configured to send secondary content based on the timing data. For example, the APS 201 may be configured to cause secondary content to be output at one or more premises based on the timing data. The APS 201 may be configured to generate (e.g., determine) one or more audio fingerprints.

The audio fingerprints may be caused to be output one or more times during output of the secondary content. For example, the one or more audio fingerprints may be caused to be output at the beginning of a segment of secondary content, at the one-quarter mark, the half-way mark, and an end of a segment of secondary content. This way, it may further be determined not only that secondary content was output, but also how much of the secondary content was output before, for example, a user tuned away or requested alternate content.

APS 201 may be configured to receive audio data from one or more premises devices (e.g., media device 120, one or more audio devices 125, and/or gateway device 122). The audio data may be associated with content (e.g., primary content and/or secondary content). For example, one or more audio devices at the premises may detect the audio data and send the audio data to the APS 201. For example, the one or more audio devices may comprise one or more devices configured to receive audio data (e.g., analog or digital) and process the audio data. The one or more audio devices may comprise one or more user devices such as smartphones, laptops, computers, smartwatches, smart car buds, voice activated devices such as smart remotes or smart speakers, combinations thereof, and the like.

The APS 201 may be configured to determine the audio data comprises the one or more audio fingerprints. In this case, the APS 201 may be configured to update a first table (e.g., table 202). For example, the APS 201 may be configured to determine, based on the audio fingerprint, a device ID associated with a device that output the content, a device ID associated with a device that detected the output content, and/or a timestamp associated with one or more of a time at which the content was output and/or a time at which the output content was detected (which may ostensibly be approximately the same time, depending on the location of the microphones and speakers involved).

The APS 201 may be configured to determine the audio data does not comprise the one or more audio fingerprints (e.g., the audio data is not associated with a fingerprinted item of content). In this case, the APS 201 may be configured to generate an audio fingerprint and associate the audio fingerprint with the content (e.g., as shown in table 203). For example, the APS 201 may be configured to convert audio data to a string representation such as VARCHAR. For example, the APS 201 may receive detected audio from one or more audio devices, determine audio data in a format such as MP3 or WAV, and convert the audio data to the string representation.

The APS 201 may be configured to determine one or more content schedules (e.g., ad schedules). For example, the APS 201 may be configured to determine one or more ad rotations, one or more exposure settings (e.g., based on a desired exposure frequency, audience demographics, ad campaign settings, combinations thereof, and the like).

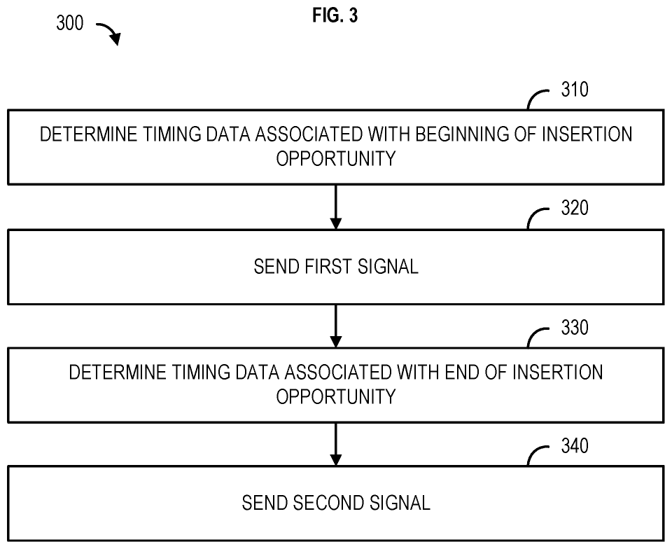

FIG. 3 is a flowchart of an example method 300. The method may be carried out by any one or more devices described herein. At 310, timing data associated with one or more content insertion opportunities may be determined. The one or more content insertion opportunities may be indicated in a first manifest file. For example, a computing device may receive a manifest file. For example, the secondary content source may receive the manifest file. The manifest file may comprise the timing data, one or more file names, one or more paths, one or more file locations, one or more file sizes, one or more file dependencies, package metadata, one or more installation instructions, combinations thereof, and the like. The manifest file may be received by the secondary content device from a premises device and/or a primary content source. For example, the premises device may comprise a gateway device that received the first manifest file based on a request from a media device. The first manifest file may indicate one or more first content insertion opportunities.

At 320, a first signal may be sent to the premises device. For example, the secondary content source may send the signal to the premises device. The signal sent to the premises device may be configured to cause the premises device to activate one or more audio devices. The premises device may comprise, for example, one or more of: a gateway device, an access point, a set-top-box, combinations thereof, and the like.

At 330, timing data associated with an end of the content insertion opportunity may be determined. The timing data associated with the end of the content insertion point may be determined based on the first manifest file and/or a second manifest file. For example, a second manifest file may be received. The second manifest file may comprise second timing data, one or more second file names, one or more second paths, one or more second file locations, one or more second file sizes, one or more second file dependencies, second package metadata, one or more second installation instructions, combinations thereof, and the like. The second manifest file may comprise one or more second content insertion opportunities.

At 340, a second signal may be sent. The second signal may be sent from the computing device (e.g., the secondary content source) to the premises device (e.g., the gateway device 122, the media device 120, the mobile device 124, and/or the audio device 125). The second signal may be configured to cause one or more audio devices to deactivate (e.g., turn off one or more microphones, stop processing audio data). The second signal may be sent based on receiving the second manifest file.

The method may comprise sending secondary content. The method may comprise determining, based on one or more identifiers associated with one or more of the first manifest file and the second manifest file, one or more devices (e.g., an identifier associated with gateway device 122, an identifier associated with media device 120, an identifier associated with mobile device 124). For example, any device at premises may make a request for content, the gateway device 122 may determine the outgoing request and the incoming first manifest file, and determine, based on the outgoing request for content, a device that originated the request. The method may comprise receiving audio data captured by the one or more audio devices. The method may comprise determining, based on the audio data captured by the one or more audio devices, an error.

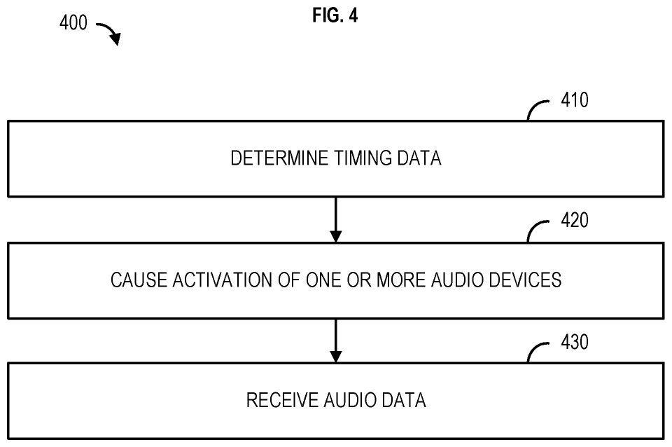

FIG. 4 is a flowchart of an example method 400. The method may be carried out by any one or more devices described herein. At 410, timing data may be determined. The timing data may be associated with one or more content insertion opportunities. The timing data may be determined based on a manifest file. For example, a computing device may receive a manifest file and determine the timing data. The timing data may indicate a start time or stop time for the one or more content insertion opportunities. The one or more content insertion opportunities may be associated with one or more secondary content schedules (e.g., one or more advertisement schedules).

At 420, one or more audio devices may be activated. For example, the one or more audio devices may comprise one or more devices configured to receive audio data (e.g., analog or digital) and process the audio data. The one or more audio devices may comprise one or more user devices such as smartphones, laptops, computers, smartwatches, smart ear buds, voice activated devices such as smart remotes or smart speakers, combinations thereof, and the like.

At 430, audio data detected by the one or more audio devices may be received. The audio data detected by the one or more audio devices may comprise or otherwise be associated with one or more audio fingerprints. The one or more audio fingerprints may be configured to identify or otherwise may be associated with primary content or secondary content.

The method may comprise receiving a second manifest file. The method may comprise determining, based on the second manifest file, secondary content associated with a current time. The method may comprise sending a signal configured to cause the one or more audio devices to remain active for a period of time. The method may comprise sending a signal configured to deactivate the one or more audio devices. The method may comprise determining, based on one or more identifiers associated with the manifest file, the one or more audio devices, wherein the one or more identifiers identify one or more of: a premises device, a gateway device, a set-top-box, or one or more audio devices, wherein the one or more audio devices comprise one or more microphones and wherein causing the one or more audio devices to activate comprises causing the one or more microphones to turn on. The method may comprise sending secondary content. The method may comprise generating one or more audio fingerprints. The one or more audio fingerprints may be generated based on the manifest file. The one or more audio fingerprints may be generated based on audio data associated with content (e.g., a version of the audio data). The one or more audio fingerprints may be determined based on one or more identifiers associated with the content or one or more device identifiers. The method may comprise causing, based on the one or more content insertion opportunities, output of secondary content. The method may comprise receiving, from the one or more audio devices, an indication that the secondary content was output.

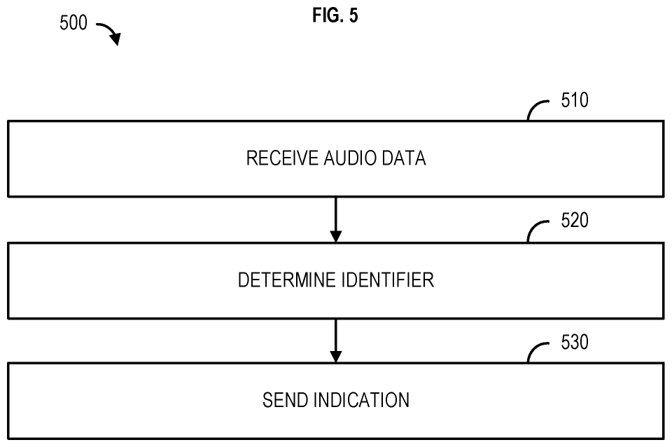

FIG. 5 is a flowchart of an example method 500. The method may be carried out by any one or more devices described herein. At 510, audio data may be received. The audio data may be received by a computing device (e.g., the secondary content source 104). The audio data may be detected by one or more audio devices. The one or more audio devices may send the audio data to a computing device (e.g., the secondary content source 104). The one or more audio devices may be located at a premises. The one or more audio devices may comprise one or more microphones. The one or more audio devices may comprise one or more user devices such as smartphones, laptops, computers, smartwatches, smart ear buds, voice activated devices such as smart remotes or smart speakers, combinations thereof, and the like. The audio data may be analog or digital. The audio data may be detected (e.g., determined) by the one or more audio devices based on sound output by another device at the premises (e.g., a speaker, the television, a user device, etc . . . ). The audio data may comprise one or more audio fingerprints.

At 520, an identifier associated with content may be determined. The identifier associated with the content may be determined by a computing device based on the audio data detected by the one or more audio devices. The audio data may be detected based on timing data. For example, the audio data may be detected based on timing data in a manifest file. For example, the one or more audio devices may be activated (e.g., turned on, enter a listen mode, etc.) based on the timing date in the manifest file.

At 530, an indication may be sent. The indication may indicate a time the content was output (e.g., a time the audio data was detected by the one or more audio devices). The timing data may

The method may comprise comparing the audio fingerprint to a list of one or more audio fingerprints. The method may comprise determining, based on the comparison, a content identifier. The method may comprise causing a computing device to update a secondary content schedule. The method may comprise receiving a manifest file. The method may comprise sending secondary content. The method may comprise sending the secondary content based on the manifest file.

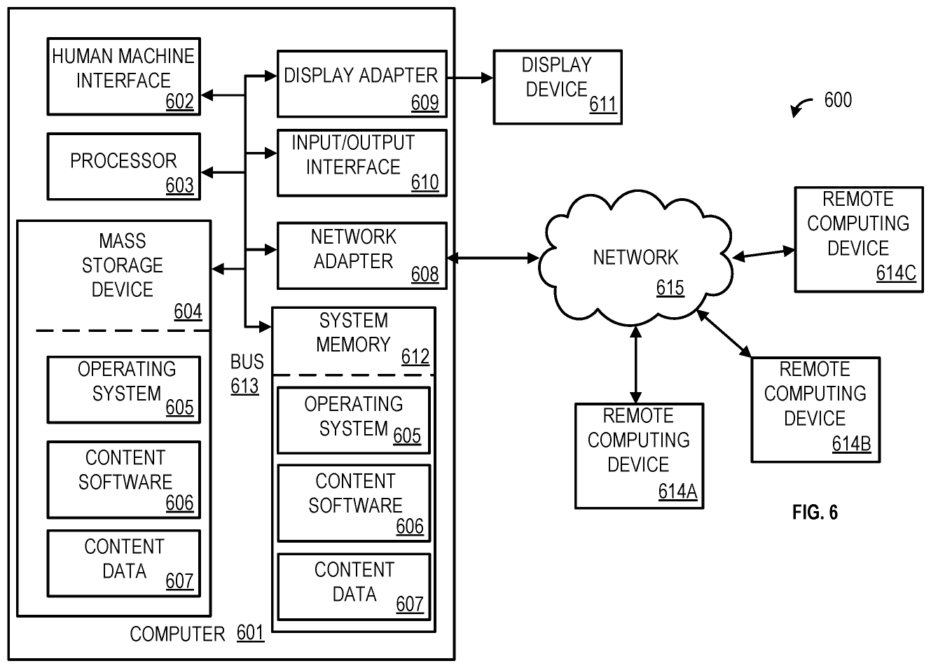

The methods and systems can be implemented on a computer 601 as illustrated in FIG. 6 and described below. By way of example, the gateway device 122 of FIG. 1 can be a computer 601 as illustrated in FIG. 6. Similarly, the methods and systems disclosed can utilize one or more computers to perform one or more functions in one or more locations. FIG. 6 is a block diagram illustrating an example operating environment 600 for performing the disclosed methods. This example operating environment 600 is only an example of an operating environment and is not intended to suggest any limitation as to the scope of use or functionality of operating environment architecture. Neither should the operating environment 600 be interpreted as having any dependency or requirement relating to any one or combination of components illustrated in the example operating environment 600.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage content including memory storage devices.

Further, one skilled in the art will appreciate that the systems and methods disclosed herein can be implemented via a general-purpose computing device in the form of a computer 601. In an aspect, the computer 601 can serve as the content provider. The computer 601 can comprise one or more components, such as one or more processors 603, a system memory 612, and a bus 613 that couples various components of the computer 601 including the one or more processors 603 to the system memory 612. In the case of multiple processors 603, the operating environment 600 can utilize parallel computing.

The bus 613 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and one or more of the components of the computer 601, such as the one or more processors 603, a mass storage device 604, an operating system 605, content software 606, content data 607, a network adapter 608, system memory 612, an Input/Output Interface 610, a display adapter 609, a display device 611, and a human machine interface 602, can be contained within one or more remote computing devices 614A,B,C at physically separate locations, connected through buses of this form, in effect implementing a fully distributed system.

The computer 601 typically comprises a variety of computer readable content. Example readable content can be any available content that is accessible by the computer 601 and comprises, for example and not meant to be limiting, both volatile and non-volatile content, removable and non-removable content. The system memory 612 can comprise computer readable content in the form of volatile memory, such as random access memory (RAM), and/or non-volatile memory, such as read only memory (ROM). The system memory 612 typically can comprise data such as content data 607 and/or program modules such as operating system 605 and content software 606 that are content accessible to and/or are operated on by the one or more processors 603.

In another aspect, the computer 601 can also comprise other removable/non-removable, volatile/non-volatile computer storage content. The mass storage device 604 can provide non-volatile storage of computer code, computer readable instructions, data structures, program modules, and other data for the computer 601. For example, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and content software 606. The content data 607 can also be stored on the mass storage device 604. Content data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 615.

In an aspect, the user can enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 603 via a human machine interface 602 that is coupled to the bus 613, but can be connected by other interface and bus structures, such as a parallel port, game port, an IEEE 1394 Port (also known as a Firewire port), a serial port, network adapter 608, and/or a universal serial bus (USB).

In yet another aspect, a display device 611 can also be connected to the bus 613 via an interface, such as a display adapter 609. It is contemplated that the computer 601 can have more than one display adapter 609 and the computer 601 can have more than one display device 611. For example, a display device 611 can be a monitor, an LCD (Liquid Crystal Display), light emitting diode (LED) display, television, smart lens, smart glass, and/or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like. The display 611 and computer 601 can be part of one device, or separate devices.

The computer 601 can operate in a networked environment using logical connections to one or more remote computing devices 614A,B,C. By way of example, a remote computing device 614A,B,C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 601 and a remote computing device 614A,B,C can be made via a network 615, such as a local area network (LAN) and/or a general wide area network (WAN). Such network connections can be through a network adapter 608. The network adapter 608 can be implemented in both wired and wireless environments. Such networking environments are conventional and commonplace in dwellings, offices, enterprise-wide computer networks, intranets, and the Internet. In an aspect, the remote computing devices 614A,B,C can serve as first and second devices for displaying content. For example, the remote computing device 614A can be a first device for displaying portions of primary content, and one or more of the remote computing devices 614B,C can be a second device for displaying secondary content. As described above, the secondary content is provided to the second device (e.g., one or more of the remote computing devices 614B,C) in lieu of providing the secondary content to the first device (i.e., the remote computing device 614A). This allows the first device to display multiple portions of primary content contiguously, without in-line breaks for secondary content.

For purposes of illustration, application programs and other executable program components such as the operating system 605 are illustrated herein as discrete blocks, although it is recognized that such programs and components can reside at various times in different storage components of the computing device 601, and are executed by the one or more processors 603 of the computer 601. An implementation of content software 606 can be stored on or transmitted across some form of computer readable content. Any of the disclosed methods can be performed by computer readable instructions embodied on computer readable content. The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining timing data associated with a content insertion opportunity in a first manifest file;
sending, to a premises device, a first signal configured to cause the premises device to activate one or more audio devices;
determining timing data associated with an end of the content insertion opportunity; and
sending, to the premises device, a second signal configured to cause the premises device to deactivate the one or more audio devices.

2. The method of claim 1, wherein the premises device comprises a gateway and wherein the one or more audio devices comprise one or more microphones.

3. The method of claim 1, wherein the first manifest file comprises one or more content insertion opportunities, the method further comprising sending, based on the one or more content insertion opportunities, secondary content.

4. The method of claim 1, further comprising determining, based on the first manifest file, one or more device identifiers.

5. The method of claim 1, further comprising:
receiving audio data captured by the one or more audio devices; and
determining, based on the audio data, an error.

6. The method of claim 5, wherein determining the error comprises receiving an incomplete audio fingerprint.

7. A method comprising:
determining, based on a manifest file, timing data associated with one or more content insertion opportunities;
causing, based on the timing data, activation of one or more audio devices; and
receiving audio data detected by the one or more audio devices.

8. The method of claim 7, wherein the one or more content insertion opportunities as associated with one or more advertisement schedules.

9. The method of claim 7, wherein the timing data indicates one or more of a start time or an end time of the one or more content insertion opportunities.

10. The method of claim 7, further comprising:
receiving a second manifest file;
determining, based on the second manifest file, secondary content associated with a current time; and
sending a signal configured to cause the one or more audio devices to remain active for a period of time.

11. The method of claim 7, further comprising:
receiving a second manifest file; and
based on receiving the second manifest file, sending a signal configured to deactivate the one or more audio devices.

12. The method of claim 7, further comprising determining, based on one or more identifiers associated with the manifest file, the one or more audio devices, wherein the one or more identifiers identify one or more of: a premises device, a gateway device, a set-top-box, or the one or more audio devices, wherein the one or more audio devices comprise one or more microphones and wherein causing the one or more audio devices to activate comprises causing the one or more microphones to turn on.

13. The method of claim 7, further comprising sending, based on the one or more content insertion opportunities, secondary content.

14. The method of claim 7, further comprising:
generating, based on the manifest file, one or more audio fingerprints; and
sending the one or more audio fingerprints.

15. The method of claim 7, further comprising:
causing, based on the one or more content insertion opportunities, output of secondary content; and
receiving, from the one or more audio devices, an indication that the secondary content was output.

16. A method comprising:
receiving audio data detected by one or more audio devices based on timing data in a manifest file;
determining, based on the audio data, an identifier associated with content; and
sending, based on the identifier and the timing data, an indication comprising a time that the content was output.

17. The method of claim 16, wherein the one or more audio devices comprise one or more microphones and wherein the timing data indicates one or more of a beginning or an end of one or more content insertion opportunities.

18. The method of claim 16, wherein the identifier associated with the content comprises an audio fingerprint, the method further comprising:
comparing the audio fingerprint to a list of one or more audio fingerprints; and
based on the comparison, determining a content identifier.

19. The method of claim 16, further comprising causing, based on the indication, a computing device to update a secondary content schedule.

20. The method of claim 16, further comprising:
receiving the manifest file; and
sending, based on the manifest file, secondary content.
